(19) United States
(12) Patent Application Publication
(10) Pub. No.: US 2022/0165241 A1
(43) Pub. Date: May 26, 2022

(54) TRANSPARENT ACOUSTIC ABSORBER-DIFFUSERS AND METHODS

(71) Applicant: CORNING INCORPORATED, Corning, NY (US)

(72) Inventors: Eric Louis Null, Corning, NY (US); Prashanth Abraham Vanniamparambil, Ellicott, MD (US)

(21) Appl. No.: 17/599,615

(22) PCT Filed: Mar. 20, 2020
(86) PCT No.: PCT/US2020/023889

§ 371 Date: Sep. 29, 2021

Related U.S. Application Data
(60) Provisional application No. 62/827,160, filed on Mar. 31, 2019.

(51) Int. Cl. G10K 11/162; B32B 17/10; B32B 3/26; B32B 7/12

(52) U.S. Cl. CPC G10K 11/162; B32B 17/10541; B32B 17/10036; B32B 3/266; B32B 2307/412; B32B 17/10807; B32B 7/12; B32B 2307/102; B32B 17/10651

(57) ABSTRACT

Transparent or translucent sound diffuser-absorbers include a first glass sheet of less than 0.8 mm thickness and a second glass sheet of less than 0.8 mm thickness with a transparent or translucent adhesive layer there between, the adhesive layer adhering the first and second sheets in a fixed configuration such that a first major surface of the first glass sheet has a smooth, repeatedly rising and falling shape. The diffuser-absorbers further include a plurality of through-holes extending through the first glass sheet and through the adhesive layer and through the second glass sheet. Methods of forming are also disclosed.

### CROSS-REFERENCE TO RELATED APPLICATIONS

This application claims the benefit of priority under 35 U.S.C. § 119 of U.S. Provisional Application No. 62/827,160 filed Mar. 31, 2019, the content of which is incorporated herein by reference in its entirety.

### FIELD OF THE DISCLOSURE

The disclosure relates to transparent acoustic absorber-diffusers and to methods for preparing transparent acoustic absorber-diffusers.

### BACKGROUND

In most room acoustics applications, there is a need to achieve the right balance between acoustic reverberation and an acoustically dead room. This is typically achieved by using separate acoustic diffusers and absorbers. Combination absorber-diffusers may also be employed. For compatibility with various rooms and room structures, particularly for smaller rooms, low weight and compactness are desirable. For aesthetically pleasing acoustic absorber-diffusers, it would be desirable to provide transparent acoustic absorber-diffusers having both low weight and compactness with design-tunable absorption and dispersion.

### SUMMARY OF THE DISCLOSURE

According to some aspects of the present disclosure, a method of forming a transparent or translucent structure for sound diffusing and sound absorbing is provided, the method comprising laminating a first glass sheet having a first major surface and a second major surface connected by an edge surface and a thickness measured from the first major surface to the second major surface of less than 0.8 mm, the edge surface of the first glass sheet having a shape, when viewed in a direction generally normal to the first major surface thereof, to a second glass sheet having first and second major surfaces connected by an edge surface and a thickness measured from the first major surface to the second major surface of less than 0.8 mm, the edge surface of the second glass sheet having a shape, when viewed in a direction generally normal to the first major surface thereof, generally matching the shape of the first glass sheet. The sheets are laminated together using a transparent or translucent adhesive layer between the second major surface of the first glass sheet and the first major surface of glass sheet, adhering the second major surface of the first glass sheet to the first major surface of the second glass sheet in a fixed configuration, such that the first major surface of the first glass sheet has a smooth, repeatedly rising and falling shape.

The method further comprises providing a plurality of through-holes extending from the first surface of the first glass sheet through the first glass sheet and through the adhesive layer and through the second glass sheet to the second surface of the second glass sheet

According to additional aspects of the present disclosure, a transparent or translucent structure for sound diffusing and sound absorbing is provided. The structure comprises a first glass sheet having a first major surface and a second major surface connected by an edge surface and a thickness measured from the first major surface to the second major surface of less than 0.8 mm, the edge surface of the first glass sheet having a shape, when viewed in a direction generally normal to the first major surface thereof; a second glass sheet having first and second major surfaces connected by an edge surface and a thickness measured from the first major surface to the second major surface of less than 0.8 mm, the edge surface of the second glass sheet having a shape, when viewed in a direction generally normal to the first major surface thereof, generally matching the shape of the first glass sheet; a transparent or translucent adhesive layer between the second major surface of the first glass sheet and the first major surface of glass sheet adhering the second major surface of the glass sheet to the first major surface of the second glass sheet in a fixed configuration, such that the first major surface of the first glass sheet has a smooth, repeatedly rising and falling shape; and a plurality of through-holes extending from the first surface of the first glass sheet through the first glass sheet and through the adhesive layer and through the second glass sheet to the second surface of the second glass sheet.

Additional features and advantages will be set forth in the detailed description which follows, and will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the disclosure and the appended claims.

The accompanying drawings are included to provide a further understanding of principles of the disclosure, and are incorporated in, and constitute a part of, this specification. The drawings illustrate one or more embodiment(s) and, together with the description, serve to explain, by way of example, principles and operation of the disclosure. It is to be understood that various features of the disclosure disclosed in this specification and in the drawings can be used in any and all combinations. By way of non-limiting examples, the various features of the disclosure may be combined with one another according to the following embodiments.

### BRIEF DESCRIPTION OF THE DRAWINGS

The following is a brief description of the figures in the accompanying drawings. The figures are not necessarily to scale, and certain features and certain views of the figures may be shown exaggerated in scale or in schematic in the interest of clarity and conciseness.

In the drawings:

FIG. 1 is a perspective view illustrating steps of a process according to at least one embodiment of the disclosure;

FIG. 2 is a perspective view illustrating one or more additional steps of a process according to at least one embodiment of the disclosure;

FIG. 3 is a is a perspective view illustrating one or more additional steps of a process according to at least one embodiment of the disclosure and showing least one embodiment of products according to the disclosure;

FIG. 4 is a perspective view showing an additional embodiment of products according to the disclosure;

FIG. 5 is a perspective view showing an additional embodiment of products according to the disclosure; and

FIG. 6 is a perspective view showing an additional embodiment of products according to the disclosure.

### DETAILED DESCRIPTION OF THE PREFERRED EMBODIMENTS

Additional features and advantages will be set forth in the detailed description which follows and will be apparent to those skilled in the art from the description, or recognized by practicing the embodiments as described in the following description, together with the claims and appended drawings.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions.

Modifications of the disclosure will occur to those skilled in the art and to those who make or use the disclosure. Therefore, it is understood that the embodiments shown in the drawings and described above are merely for illustrative purposes and not intended to limit the scope of the disclosure, which is defined by the following claims, as interpreted according to the principles of patent law, including the doctrine of equivalents.

For purposes of this disclosure, the term “coupled” (in all of its forms: couple, coupling, coupled, etc.) generally means the joining of two components directly or indirectly to one another. Such joining may be stationary in nature or movable in nature. Such joining may be achieved with the two components and any additional intermediate members being integrally formed as a single unitary body with one another or with the two components. Such joining may be permanent in nature, or may be removable or releasable in nature, unless otherwise stated.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

Directional terms as used herein—for example up, down, right, left, front, back, top, bottom—are made only with reference to the figures as drawn and are not intended to imply absolute orientation.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

In general, the disclosure is directed to transparent (or translucent) acoustic absorber-diffusers and methods for forming such absorber-diffusers, particularly to transparent of translucent glass absorber-diffusers and methods of forming such.

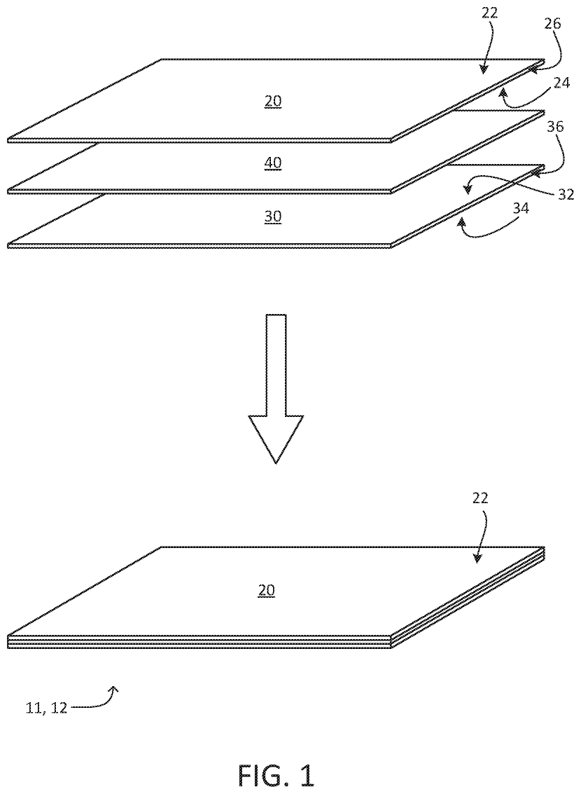

According to embodiments and with reference to FIGS. 1-3, a method for forming a transparent or translucent glass-containing absorber-diffuser comprises laminating a first glass sheet 20 having a first major surface 22 and a second major surface 24 connected by an edge surface 26, and a thickness measured from the first major surface to the second major surface of less than 0.8 mm, to a second glass sheet 30 having first and second major surfaces 32, 34 connected by an edge surface 36 and a thickness measured from the first major surface to the second major surface of less than 0.8 mm.

The edge surface 26 of the first glass sheet 20 has a shape, when viewed in a direction generally normal to the first major surface 22 thereof, and the second glass sheet 30 has a shape, when viewed in a direction generally normal to the first major surface 32 thereof, generally matching the shape of the first glass sheet. The first glass sheet 20 and the second glass sheet 30 are laminated to each other using a transparent or translucent adhesive layer 40 positioned between the second major surface 24 of the first glass sheet 20 and the first major surface 32 of the second glass sheet 30, adhering the second major surface 24 of the first glass sheet 20 to the first major surface 32 of the second glass sheet 30 in a fixed configuration, such that the first major surface 22 of the first glass sheet 20 has a smooth, repeatedly rising and falling shape (such as shown in FIG. 3).

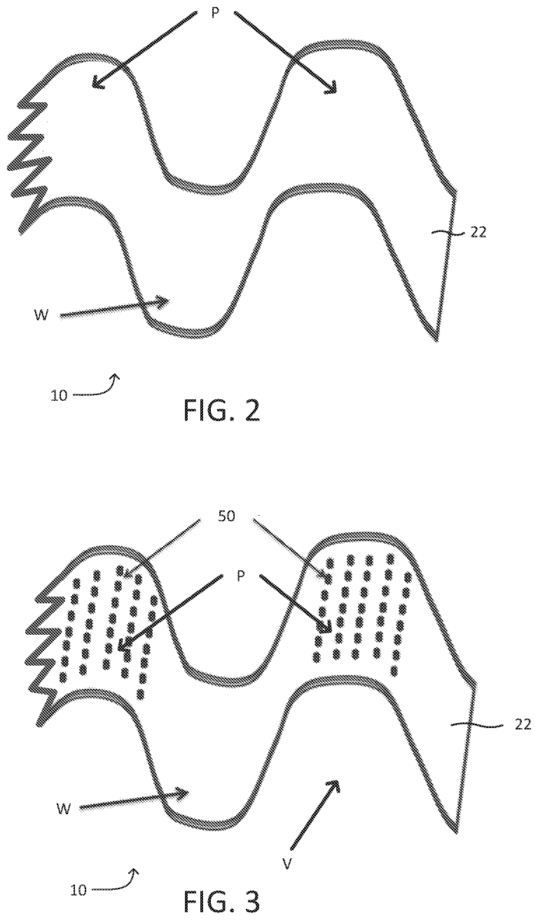

This may be achieved by stacking the first and second glass sheets 20, 30 with the adhesive layer 40 as illustrated in FIG. 1 to form a stack 11, then forming the stack 11 together in a mold or in other fixture (not shown) to impose a shape such as the one shown in FIG. 3, while curing or otherwise setting the adhesive layer 40 to form a laminated structure 10 as in FIG. 2. Alternatively, in the case of an adhesive layer which is thermoplastic, for example, the adhesive layer may optionally be set and the laminating first completed in a flat configuration as shown at the bottom of FIG. 1 to form a flat limited structure 12, and the flat laminated structure 12 may be reformed, using a mold or other fixture, by holding the flat laminated structure in a shape—or gradually bringing the flat laminated structure to a shape—such as the shape shown in FIG. 2, while heating the laminated structure then allowing it to cool, such that a laminated structure 10 such as the one of FIG. 2 results, once the mold or other fixturing is removed. Either way, a laminated structure 10 is produced where the upper surface 22 of the sheet 20 has a periodic shape with one or more wells W and protrusions P alternating along the structure 10.

The method further comprises providing a plurality of through-holes 50 (FIG. 3) extending from the first surface 22 of the first glass sheet 20 through the first glass sheet 20 and through the adhesive layer 40 and through the second glass sheet 20 to the second surface 34 of the second glass sheet 30. The through holes 50 may be provided by processes such as water jetting, laser drilling, laser drilling plus chemical removal (such as etching for the glass sheets, and oxidizing for the adhesive layer). Although the through holes 50 are illustrated in FIGS. 1-3 only in FIG. 3, the through holes 50 may be formed by providing through holes in both the first and the second glass sheets 20, 30 and in the polymer layer 40, at any earlier stage of formation of the laminate structure 10. For example, holes may be formed in two (or more) stacked of glass sheets (such as in first and second glass sheets 20, 30) simultaneously by laser drilling or laser damage and etching. Holes in the adhesive layer may then be formed after assembly of the flat laminated structure 12 or of the laminate structure 12, using the glass sheets 20, 30 as a mask.

The resulting product, an embodiment of which is represented in FIG. 3, is a transparent or translucent structure for sound diffusing and sound absorbing, with the structure comprising: (1) a first glass sheet having a first major surface and a second major surface connected by an edge surface and a thickness measured from the first major surface to the second major surface of less than 0.8 mm, the edge surface of the first glass sheet having a shape, when viewed in a direction generally normal to the first major surface thereof; (2) a second glass sheet having first and second major surfaces connected by an edge surface and a thickness measured from the first major surface to the second major surface of less than 0.8 mm, the edge surface of the second glass sheet having a shape, when viewed in a direction generally normal to the first major surface thereof, generally matching the shape of the first glass sheet; (3) a transparent or translucent adhesive layer between the second major surface of the first glass sheet and the first major surface of glass sheet adhering the second major surface of the glass sheet to the first major surface of the second glass sheet in a fixed configuration, such that the first major surface of the first glass sheet has a smooth, repeatedly rising and falling shape; and (4) a plurality of through-holes extending from the first surface of the first glass sheet through the first glass sheet and through the adhesive layer and through the second glass sheet to the second surface of the second glass sheet.

Desirably, glass sheets 20, 30 having even lower thickness may be used, such as glass sheets having a thickness within the range of from 0.05 mm to 0.8 mm, or 0.1 mm to 0.75 mm, or from 0.1 mm to 0.7 mm, or from 0.1 mm to 0.6 mm, or from 0.1 mm to 0.55 mm, or from 0.1 mm to 0.5 mm, or within any one of the above ranges but with a lower bound of 0.15 mm, 0.2 mm, or even 0.3 mm.

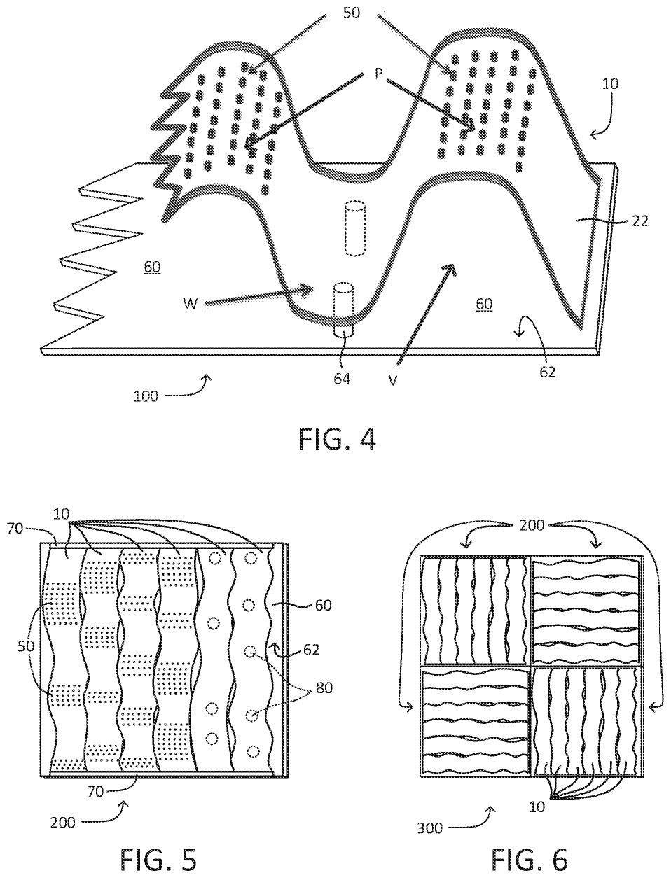

In use, the structure 10 of FIG. 3 is mounted near an architectural surface, such as surface 62 of a wall, ceiling, or (other) architectural panel 60, as shown in FIG. 4. Alternatively, the product itself may take the form of the structure 10 mounted on or near the surface 62 of the panel 60, as shown, resulting in a mounted structure 100. So mounted, the protrusions P produce, between the second surface 34 of the second glass sheet 30 and the surface 62 of the panel 60, a volume V. The volume V is at least partially enclosed by the surfaces 34 (shown in FIG. 1) and 62 (shown in FIG. 4), and may optionally be fully enclosed by walls bordering the structure 10 (not shown). The through holes 50, in cooperation with the enclosed volume(s) V, provide an acoustic absorbing function, the frequency response of which can be tuned by adjusting the shape(s) and size(s) of the holes 50 and of the volume(s) V. Furthermore, the well(s) W and the protrusions P of the rising and falling shape of the surface 22 provide an acoustic dispersing function, the frequency response of which can be tuned by adjusting the shape(s) and size(s) of the well(s) W and protrusions P. Thus the structure 10 of FIG. 3 and/or of FIG. 4 constitutes a transparent (or translucent) acoustic absorber-diffuser. Use of the glass-based laminate structure 10 in this manner, particularly with relatively thin glass sheets, provides an acoustic absorber-diffuser which is thin, light weight, and aesthetically pleasing while remaining sufficiently stiff to reduce undesirable resonance.

As shown in FIG. 4, the structure 10 can be mounted to the surface 62 by a plurality of posts 64. Alternatively, the structure 10 can be adhered directly to the surface 62 via a suitable adhesive (not shown) or can be mounted at an offset from or in contact with the surface 62 by other suitable means.

According to further embodiments, multiple structures 10 can be mounted near or directly adjacent each other, such as in the configuration shown in FIG. 5, resulting in a structure 200 comprising multiple mounted structures 10. The structure 10 or the mounted structure 100 or the structure 200 can comprise one or more light sources 70 positioned at the edge surface 26 of the first glass sheet 20 and/or at the edge surface 36 of the second glass sheet 30 (or both), as shown in the embodiment of FIG. 5. According to still further embodiments, and if desired, in any combination with other embodiments, a light source 80 or one or more light sources 80 may be included, positioned behind the second surface 34 of the second glass sheet 30. According to still further embodiments and as shown in FIG. 6, multiple structures 200 maybe mounted in combination to form a structure 300 comprising a plurality of structures 200 having more than one orientation.

According to embodiments, and in combination with any of the other embodiments or aspects, the structure of claim 1 wherein the repeatedly rising and falling shape of the surface 22 can be periodic. Alternatively, the repeatedly rising and falling shape of the surface 22 can be aperiodic. Further according to embodiments and as mentioned above, the plurality of through-holes can comprise through-holes of varying size, and further, can comprise, in addition or in alternative, through-holes of varying shape.

According to embodiments, and in combination with any of the other embodiments or aspects, the adhesive layer comprises a polymer adhesive. The polymer adhesive can comprise a PVB (polyvinyl butyral) material, and can comprise a low-plasticizer PVB (polyvinyl butyral) material. Alternatively, the polymer adhesive can comprise an EVA (ethylene-vinyl acetate copolymer) material. Alternatively, the polymer adhesive can comprise an ionoplast material, such as Sentryglas® interlayer material, available from DuPont. Desirably the ionoplast such as Sentryglas material comprises ethylene/methacrylic acid copolymers with small amounts of metal salts, and desirably has a Young's modulus of greater than 100 MPa at temperatures up to 50° C.

According to embodiments, and in combination with any of the other embodiments or aspects, the adhesive layer can be colored at least in part, or opaque at least in part, translucent (and not transparent) at least in part, or any combination of these. According to embodiments, and in combination with any of the other embodiments or aspects, at least the first glass sheet can comprise an aluminosilicate glass, or a boro-aluminosilicate glass.

According to embodiments, and in combination with any of the other embodiments or aspects, at least the first glass sheet can be an unstrengthened glass sheet. Alternatively, according to embodiments and in combination with any of the other embodiments or aspects, at least the first glass sheet can be a chemically strengthened glass sheet or a thermally strengthened glass sheet or a sheet strengthened by a combination of chemical and thermal processes.

In one embodiment, a transparent or translucent structure for sound diffusing and sound absorbing is provided, the structure comprising: a first glass sheet having a first major surface and a second major surface connected by an edge surface and a thickness measured from the first major surface to the second major surface of less than 0.8 mm, the edge surface of the first glass sheet having a shape, when viewed in a direction generally normal to the first major surface thereof; a second glass sheet having first and second major surfaces connected by an edge surface and a thickness measured from the first major surface to the second major surface of less than 0.8 mm, the edge surface of the second glass sheet having a shape, when viewed in a direction generally normal to the first major surface thereof, generally matching the shape of the first glass sheet; a transparent or translucent adhesive layer between the second major surface of the first glass sheet and the first major surface of glass sheet adhering the second major surface of the glass sheet to the first major surface of the second glass sheet in a fixed configuration, such that the first major surface of the first glass sheet has a smooth, repeatedly rising and falling shape; and a plurality of through-holes extending from the first surface of the first glass sheet through the first glass sheet and through the adhesive layer and through the second glass sheet to the second surface of the second glass sheet.

In some embodiments, the structure further comprises a light source positioned at the edge surface of the first glass sheet and/or at the edge surface of the second glass sheet.

In some embodiments, the structure comprises a light source positioned behind the second surface of the second glass sheet.

In some embodiments, the structure comprises a repeatedly rising and falling shape that is periodic.

In some embodiments, the repeatedly rising and falling shape of the structure is aperiodic.

In some embodiments, the plurality of through-holes comprises through-holes of varying size.

In some embodiments, the plurality of through-holes comprises through-holes of varying shape.

In some embodiments, the adhesive layer comprises a polymer adhesive.

In some embodiments, the polymer adhesive comprises: a PVB (polyvinyl butyral) material; a low-plasticizer PVB (polyvinyl butyral) material; an EVA (ethylene-vinyl acetate copolymer) material; an ethylene/methacrylic acid copolymers with small amounts of metal salts; a composition of an ethylene/methacrylic acid copolymers containing small amounts of metal salts having a Young's modulus greater than 100 MPa at temperatures up to 50° C.; and combinations thereof.

In some embodiments, the adhesive layer is colored at least in part.

In some embodiments, the first glass sheet comprises an aluminosilicate glass; a boro-aluminosilicate glass; an unstrengthened glass sheet; a chemically strengthened glass sheet; or a thermally strengthened sheet.

In one embodiment, a method of forming a transparent or translucent structure for sound diffusing and sound absorbing, the method comprising: laminating a first glass sheet having a first major surface and a second major surface connected by an edge surface and a thickness measured from the first major surface to the second major surface of less than 0.8 mm, the edge surface of the first glass sheet having a shape, when viewed in a direction generally normal to the first major surface thereof, to a second glass sheet having first and second major surfaces connected by an edge surface and a thickness measured from the first major surface to the second major surface of less than 0.8 mm, the edge surface of the second glass sheet having a shape, when viewed in a direction generally normal to the first major surface thereof, generally matching the shape of the first glass sheet, using a transparent or translucent adhesive layer between the second major surface of the first glass sheet and the first major surface of glass sheet adhering the second major surface of the first glass sheet to the first major surface of the second glass sheet in a fixed configuration, such that the first major surface of the first glass sheet has a smooth, repeatedly rising and falling shape; and providing a plurality of through-holes extending from the first surface of the first glass sheet through the first glass sheet and through the adhesive layer and through the second glass sheet to the second surface of the second glass sheet.

In some embodiments, the method further comprises positioning a light source at the edge surface of the first glass sheet and/or at the edge surface of the second glass sheet.

In some embodiments, the method further comprises positioning a light source behind the second surface of the second glass sheet.

In some embodiments, laminating comprises laminating such that the repeatedly rising and falling shape is periodic.

In some embodiments, laminating comprises laminating such that the repeatedly rising and falling shape is aperiodic.

In some embodiments, providing a plurality of through-holes comprises providing through-holes of varying size.

In some embodiments, providing a plurality of through-holes comprises providing through-holes of varying shape.

In some embodiments, the adhesive layer comprises a polymer adhesive.

In some embodiments, the polymer adhesive is at least one of: a PVB (polyvinyl butyral) material; a low-plasticizer PVB (polyvinyl butyral) material; an EVA (ethylene-vinyl acetate copolymer) material; a composition of ethylene/methacrylic acid copolymers with small amounts of metal salts; a composition of an ethylene/methacrylic acid copolymers containing small amounts of metal salts having a Young's modulus greater than 100 MPa at temperatures up to 50° C.; and combinations thereof. In some embodiments, the adhesive layer is colored at least in part.

In some embodiments, the first glass sheet comprises: an aluminosilicate glass; a boro-aluminosilicate glass; an unstrengthened glass sheet; or a chemically strengthened glass sheet, or a thermally strengthened glass sheet. In some embodiments, laminating further comprises holding the first glass sheet, the second glass sheet, and the polymer adhesive layer in a position corresponding to the fixed configuration while curing the polymer adhesive layer.

While exemplary embodiments and examples have been set forth for the purpose of illustration, the foregoing description is not intended in any way to limit the scope of disclosure and appended claims. Accordingly, variations and modifications may be made to the above-described embodiments and examples without departing substantially from the spirit and various principles of the disclosure. All such modifications and variations are intended to be included herein within the scope of this disclosure and protected by the following claims.

1. A transparent or translucent structure for sound diffusing and sound absorbing, the structure comprising:
a first glass sheet having a first major surface and a second major surface connected by an edge surface and a thickness measured from the first major surface to the second major surface of less than 0.8 mm, the edge surface of the first glass sheet having a shape, when viewed in a direction generally normal to the first major surface thereof;
a second glass sheet having first and second major surfaces connected by an edge surface and a thickness measured from the first major surface to the second major surface of less than 0.8 mm, the edge surface of the second glass sheet having a shape, when viewed in a direction generally normal to the first major surface thereof, generally matching the shape of the first glass sheet;
a transparent or translucent adhesive layer between the second major surface of the first glass sheet and the first major surface of glass sheet adhering the second major surface of the glass sheet to the first major surface of the second glass sheet in a fixed configuration, such that the first major surface of the first glass sheet has a smooth, repeatedly rising and falling shape; and
a plurality of through-holes extending from the first surface of the first glass sheet through the first glass sheet and through the adhesive layer and through the second glass sheet to the second surface of the second glass sheet.

2. The structure of claim 1 further comprising a light source positioned at the edge surface of the first glass sheet and/or at the edge surface of the second glass sheet.

3. The structure of claim 1 further comprising a light source positioned behind the second surface of the second glass sheet.

4. The structure of claim 1 wherein the repeatedly rising and falling shape is periodic.

5. The structure of claim 1 wherein the repeatedly rising and falling shape is aperiodic.

6. The structure of claim 1 wherein the plurality of through-holes comprises through-holes of varying size.

7. The structure of claim 1 wherein the plurality of through-holes comprises through-holes of varying shape.

8. The structure of claim 1 wherein the adhesive layer comprises a polymer adhesive.

9. The structure of claim 8 wherein the polymer adhesive comprises: a PVB (polyvinyl butyral) material; a low-plasticizer PVB (polyvinyl butyral) material; an EVA (ethylene-vinyl acetate copolymer) material; an ethylene/methacrylic acid copolymers with small amounts of metal salts; a composition of an ethylene/methacrylic acid copolymers containing small amounts of metal salts having a Young's modulus greater than 100 MPa at temperatures up to 50° C.; and combinations thereof.

10. The structure of claim 1 wherein the adhesive layer is colored at least in part.

11. The structure of claim 1 wherein at least the first glass sheet comprises an aluminosilicate glass; a boro-aluminosilicate glass; an unstrengthened glass sheet; a chemically strengthened glass sheet; or a thermally strengthened sheet.

12. A method of forming a transparent or translucent structure for sound diffusing and sound absorbing, the method comprising:
laminating a first glass sheet having a first major surface and a second major surface connected by an edge surface and a thickness measured from the first major surface to the second major surface of less than 0.8 mm, the edge surface of the first glass sheet having a shape, when viewed in a direction generally normal to the first major surface thereof, to a second glass sheet having first and second major surfaces connected by an edge surface and a thickness measured from the first major surface to the second major surface of less than 0.8 mm, the edge surface of the second glass sheet having a shape, when viewed in a direction generally normal to the first major surface thereof, generally matching the shape of the first glass sheet, using a transparent or translucent adhesive layer between the second major surface of the first glass sheet and the first major surface of glass sheet adhering the second major surface of the first glass sheet to the first major surface of the second glass sheet in a fixed configuration, such that the first major surface of the first glass sheet has a smooth, repeatedly rising and falling shape; and
providing a plurality of through-holes extending from the first surface of the first glass sheet through the first glass sheet and through the adhesive layer and through the second glass sheet to the second surface of the second glass sheet.

13. The method of claim 12 further comprising positioning a light source at the edge surface of the first glass sheet and/or at the edge surface of the second glass sheet.

14. The method of claim 12 further comprising positioning a light source behind the second surface of the second glass sheet.

15. The method of claim 12 wherein laminating comprises laminating such that the repeatedly rising and falling shape is periodic.

16. The method of claim 12 wherein laminating comprises laminating such that the repeatedly rising and falling shape is aperiodic.

17. The method of claim 12 wherein providing a plurality of through-holes comprises providing through-holes of varying size.

18. The method of claim 12 wherein providing a plurality of through-holes comprises providing through-holes of varying shape.

19. The method of claim 12 the adhesive layer comprises a polymer adhesive.

20. The method of claim 19 wherein the polymer adhesive is at least one of: a PVB (polyvinyl butyral) material; a low-plasticizer PVB (polyvinyl butyral) material; an EVA (ethylene-vinyl acetate copolymer) material; a composition of ethylene/methacrylic acid copolymers with small amounts of metal salts; a composition of an ethylene/methacrylic acid copolymers containing small amounts of metal salts having a Young's modulus greater than 100 MPa at temperatures up to 50° C.; and combinations thereof.
